(19) United States
(12) Patent Application Publication
(10) Pub. No.: US 2012/0059751 A1
(43) Pub. Date: Mar. 8, 2012

(54) SYSTEMS AND METHODS FOR MANAGING AND ALLOCATING FUNDS

(75) Inventors: Rick Hangartner, Corvallis, OR (US); Philip Jenkins, Corvallis, OR (US)

(73) Assignee: STRANDS, INC., Corvallis, OR (US)

(21) Appl. No.: 13/228,382

(22) Filed: Sep. 8, 2011

Related U.S. Application Data
(60) Provisional application No. 61/381,044, filed on Sep. 8, 2010.

(51) Int. Cl. G06Q 40/02

(52) U.S. Cl. 705/35

(57) ABSTRACT

The application discloses a systems and methods for automatically managing and allocating funds deposited in one or more financial accounts owned by the user. The system allows the user to specify and dynamically modify multiple savings goals and to associate each goal with a savings account. As the user makes deposits or withdrawals from an account, the amount of funds allocated to each of the goals associated with the account are automatically adjusted based on the user's relative preferences for the goals as automatically inferred from the user's interactions with the system. The system may also provide incentive rewards to users as they meet interim subgoals or complete a goal to induce users to successfully achieve their savings goals.

### RELATED APPLICATIONS

This non-provisional application claims priority to U.S. provisional application Ser. No. 61/381,044, filed Sep. 8, 2010, which we incorporate herein by reference.

### TECHNICAL FIELD

We describe systems and methods for the management and allocation of funds deposited in savings and other similar financial or bank accounts. More particularly, we describe technical means that assist a user in establishing multiple personal saving goals for funds deposited to multiple savings accounts, including automatic allocation of deposited funds to the multiple goals based on user preferences for those goals automatically inferred from user interactions with the system.

### BRIEF DESCRIPTION OF THE DRAWINGS

The drawings depict certain preferred embodiments but are not to be understood as in themselves limiting the scope of that described herein. They are to be considered as an aid to understanding preferred embodiments as described in more detail below.

FIG. 1 is block diagram of an embodiment that depicts certain data storage, computation, and user control elements of a system for managing and allocating funds.

FIG. 2 is a system diagram of one system implementation comprising network, computer server, database, user client computer and communication devices with graphical display capabilities.

FIG. 3 is an example embodiment of a graphical display to the user of the system allocation status.

FIG. 4 is an example embodiment of a graphical user control panel for adding savings goals and specifying allocation parameters.

FIG. 5 is an example embodiment of a graphical user control panel for editing savings goals including adjusting allocations, deleting goals, and modifying allocation parameters.

FIG. 6 is a flowchart for one embodiment of a method implemented by a process in the system controlled by the graphical user control panel of FIG. 4 for adding saving goals.

FIG. 7 is a flowchart for one embodiment of a method implemented by a process in the system controlled by the graphical user control panel of FIG. 5 for editing saving goals.

FIG. 8 is a flowchart for one embodiment of a method implemented by a process in the system accessible from the graphical user control panels of FIG. 3 or FIG. 5 for deleting saving goals.

FIG. 9 is a flowchart for one embodiment of subprocesses used by the processes of FIG. 6, FIG. 7, and FIG. 8.

FIG. 10 is a flowchart of one embodiment of a method implemented by processes in the system for automatically allocating available funds to user specified savings goals at a regular time interval or when manually-initiated by a user.

FIG. 11 is a flowchart of one embodiment of a method implemented by a process in the system responsive to the graphical user control panels of FIG. 3 or FIG. 5 for manually initiating the automatic allocation of available funds to the user saving goals.

FIG. 12 is a flowchart of one embodiment of a method implemented by a process in the system for automatically allocating available funds in an account to user specified goals associated with the account responsive to user preferences for those goals as inferred from the user's interactions with the system.

### DETAILED DESCRIPTION OF PREFERRED EMBODIMENTS

The embodiments we describe herein are of systems and methods which aid people in managing their personal finances. More specifically, the systems and methods allow a user to specify multiple savings goals for the funds in multiple accounts owned by the user and automatically allocate deposits of funds in those accounts to the multiple goals. The amounts to be automatically allocated to the various goals are based on the relative preferences of the user for those goals as automatically learned from the user's interaction with certain features of embodiments of the systems and methods.

System Overview

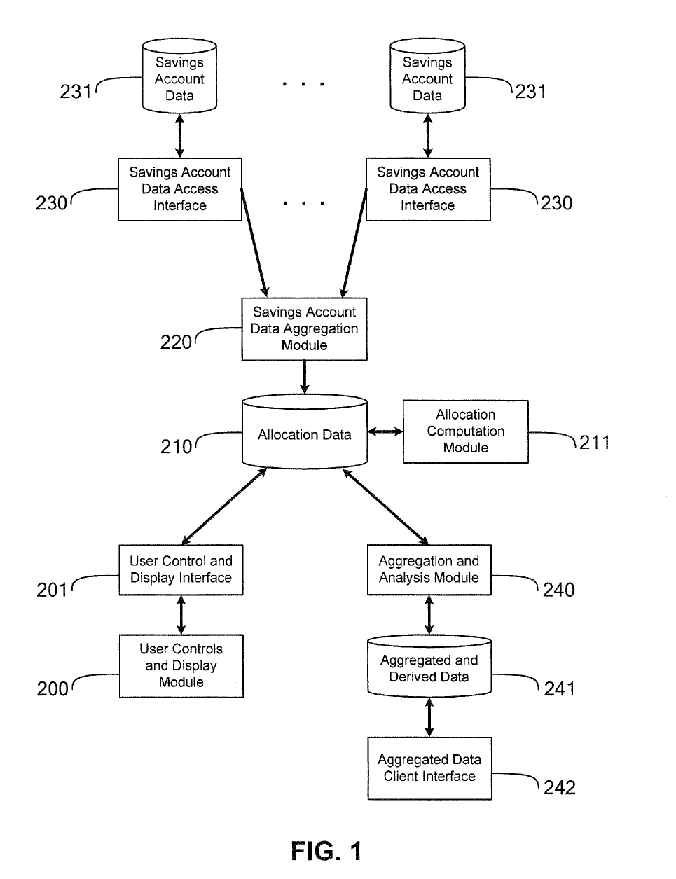

FIG. 1 is block diagram of an embodiment that depicts certain data storage, computation, and user control elements of a system for managing and allocating funds. Referring to FIG. 1, one or more savings account databases 231 serve as repositories for data about the multiple savings accounts owned by a user, including deposit and withdrawal transactions. Savings account data access interfaces 230 provide other aspects of the system and method with access to the account data stored in the databases 231.

Using the access interfaces 230, the savings account data aggregation module 220 retrieves the data for the multiple savings accounts owned by the user from the databases 231 using the access interfaces 230 and stores this data in the allocation database 210 for subsequent processing. The allocation database 210 also serves as a repository for data about user interactions as measured and logged by the user control and display interface 201. Similarly, in some embodiments the allocation database 210 serves as a repository for aggregate data about user preferences and allocations computed by the aggregation and analysis module 240.

The allocation computation module 211 retrieves the raw account data from the allocation database 210 and data about user interactions via the user interface 201 to determine allocations of user deposit transactions in the data for the multiple accounts retrieved by the data aggregation module 220 and stored in the allocation database 210. We describe the methods for determining these allocations in various embodiments later.

The user controls and display module 200 provides the graphical or other means in various embodiments by which users interact via the user control and display interface 201 to provide access to the multiple savings account they own, to specify their savings goals, and to monitor and adjust the allocations made automatically to their goals. We describe some typical embodiments of the control and displays provided to the user subsequently.

Some embodiments may include an aggregation and analysis module 241 which compiles aggregate statistics, data mines for patterns, or derives statistical inferences about user preferences and allocations for a population or sub-population of users from the data in the allocation database 210. These analysis results are stored in the aggregated and derived data database 241 for subsequent retrieval by consuming clients via the aggregated data client interface 242.

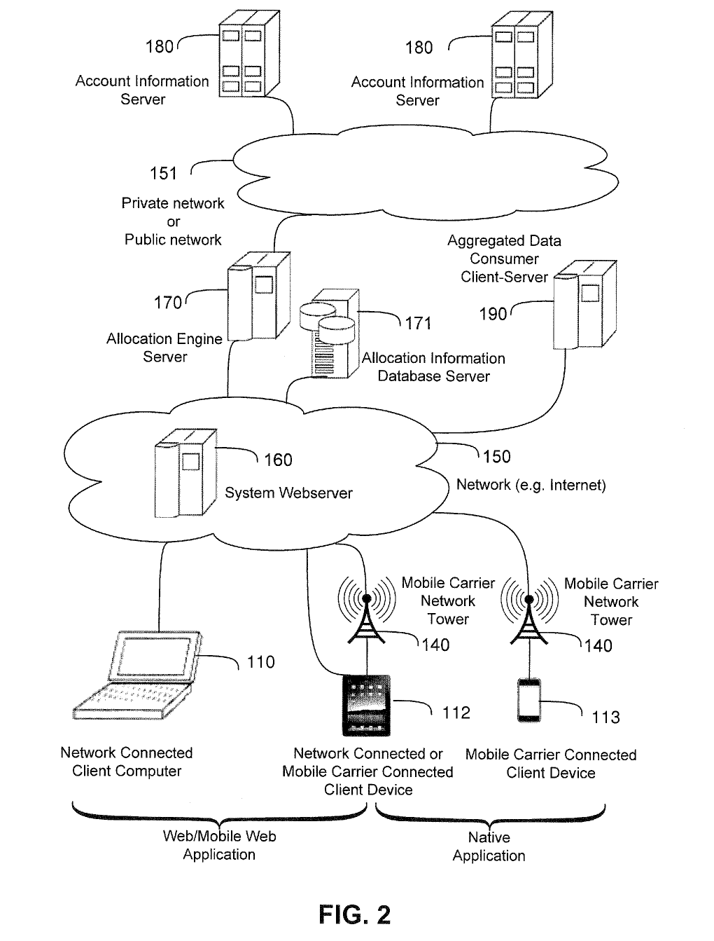

Reference is now made to FIG. 2 that depicts a system diagram of one embodiment. In this diagram, each of the multiple account information servers 180 may embody one instance of the savings account database 231 and savings account data access interface 230 of FIG. 1. The private or public network 151 provides the data communications channel between the one or more instances of the data access interface 230 and the aggregation module 220 of FIG. 1.

The allocation engine server 170 may embody the savings account data aggregation module 220 and the allocation computation module 211 of FIG. 1. The allocation data database 210 of FIG. 1 may be embodied by the allocation information server 171. The network 151 may be a private network or a public network including the Internet® that provides the data communication channel between the aggregation module 220, the allocation module 211, and the allocation database 210.

System webserver 160 and the network 150 may embody the user control and display interface 201 and the data communications channel between the allocation database 210 and the control and display interface 201.

Some embodiments may include an aggregated data consumer client-server 190 that may embody the aggregation and analysis module 240 and aggregated data client interface 241 of FIG. 1. In some embodiments, the aggregated and derived data database 241 may be incorporated in the client-server component 190, while in others it may be incorporated in the allocation information server 171. The network 150 may embody the data communications channel between the allocation database 241, the analysis module 240, the aggregated database 241, and the client interface 242, as well as the data communications channel between the client interface 242 and client systems that consume the aggregated and derived data.

Finally, in some embodiments the network connected client computer 110 and the network 150 may embody the user controls and display module 100, implemented as a web browser and web application, and the data communications channel between the user control and display interface 201 and the controls and display module 200.

In other embodiments, the user controls and display module 200 and the data communications channel between the user control and display interface 201 may be embodied by the network 150 and a mobile carrier network component that includes a mobile carrier network tower 140, a mobile connected client device 112, a web browser, and web application.

In yet other embodiments, the user controls and display module 200 and the data communications channel between the user control and display interface 201 may be embodied by the network 150 and a mobile carrier network component that includes a mobile carrier network tower 140, a mobile connected client device 112, and an application on the mobile device.

Finally, in yet other embodiments the network connected mobile client device 112 and the network 150 may embody the user controls and display module 200, implemented as a native application on the mobile device, and the data communications channel between the user control and display interface 201 and the controls and display module 200.

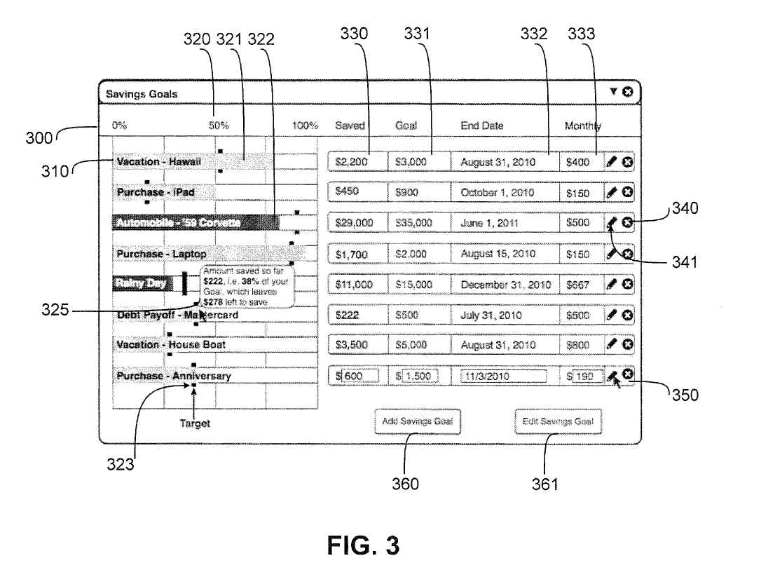

Having described the major components as embodied by the block diagram FIG. 1 and the system diagram FIG. 2, we now turn to a representative embodiments of the user control and display components in FIG. 3-FIG. 5.

User Controls and Displays

The present system and method is intended to allow customers to track progress while saving money for particular goals. These goals can be for a future purchase, or for paying off a small debt they have collected.

Goals may be embodied by data records in the allocation database 210 of FIG. 1 that include several types of information:

“Goal Category”

The user must specify a category for each goal to identify the type of goal. These categories should cover all popular goals that customers will save for, such as: “Rainy Day Savings,” “Vacation,” “Automobile,” “Electronics,” “Large Purchase,” “Home Improvement,” “Other,” and “Debt Reduction.” These categories are flexible and may be adjusted as needed to accommodate market changes or user circumstances.

“Goal Name”

The user may specify free-form text or keywords that further identify the goal.

“Goal Amount”

A key property of a goal the user defines to an embodiment is the dollar amount of the goal.

“End Date” (Date Focused Goal)

For some goals the user may choose to specify an “End Date” by when the goal must be reached. If the user specifies an “End Date” the system and method will determine a “Monthly Contribution Amount” according to the amount needed to reach the goal amount by the “End Date.”

“Monthly Contribution Amount” (Contribution-Focused Goal)

For other goals the user may choose to specify a desired “Monthly Contribution Amount.” If the user specifies a “Monthly Contribution Amount” the “End Date” will be set according to how long it will take to reach the “Goal Amount” based on the “Monthly Contribution Amount.”

Some embodiments of the system may require that the user specify either an “End Date” or a “Monthly Contribution Amount.” Other embodiments may not require the user to specify either, but instead specify a minimum default amount for any goal and a total minimum amount to be allocated to all current goals.

“Linked Account”

The user has the option to link the goal to a savings account if they want deposits automatically applied toward their goals. Multiple goals may be linked to a single savings account. Some embodiments may allow the user to specify a goal without linking it to a savings account and then to manually specify contributions towards the goal.

“Goal Priority”

The user may assign a categorical priority that indicates how important achieving the goal is to the user. Typical categorical priorities in an embodiment may be H(igh), M(edium), or L(ow). Other embodiments may allow the user to explicitly assign goals to a larger number of categories, or to completely rank-order goals.

“Amount Saved”

The system and method may track how much the user has saved for each goal. For goals linked to a savings account, the “Amount Saved” will be automatically updated based on new deposits to the savings account. For goals that are not linked to an account, the “Amount Saved” will be manually updated by the customer. In some embodiments, the user may manually modify the allocations that were made automatically by the system and method.

“Amount Remaining”

The system and method may track how much is left to save to reach the “Goal Amount” and the “Amount Saved.”

“Goal Status and Contributions”

The system and method tracks and reports to the user progress towards the goal. This may include a status indication whether the goal is in progress or completed. This may include a status indication for goals in progress whether the amount saved is on track with the projected plan. Some embodiments may retain data about completed goals and the historical record of contributions for further analysis and reporting about the individual savings behavior of individual users or the aggregated savings behavior of a group of users.

In an embodiment, the user's goals and the allocation of user contributions to those goals may be summarized in a display 300 such as that shown in FIG. 3. The display presents the user with a graphical representation, e.g. 320 and 310, and textual representation, e.g. 330, 331, 332, and 333, of progress towards each goal. In summary, the system and method stores the information about each user's goals in the allocation database 210. The display 300 communicates for each of a user's goals if the user is on track to accomplish the goal, how much the user has saved toward the goal, and how much is left to save to reach the goal.

The user display 300 of a preferred embodiment includes a bar graph that displays the goal name and show how much has been saved to date. A target marker 323 may be displayed on each bar to show what how much should be saved towards the goal on the current date the user is viewing the display. The bar graph may display status towards the goal by showing the percentage saved and may use different colors such as green to indicate if the goal is on track 321 and orange to indicate if the goal is behind 322.

In some embodiments, when the user positions a pointing device on the graphical display 310 for the goal a pop-up window 325 with a textual summary of the information in the bar graph for a goal may be displayed such as: “Amount saved so far $222, i.e. 38% of your Goal, which leaves $278 left to save”.

Additional textual information about each goal may also be displayed in some embodiments. The textual information may include any combination of the total amount saved towards the goal 330, the amount of the goal 331, the end date of the goal 332, and the monthly contribution amount towards the goal 333.

Some embodiments may include an edit button 341 for each goal that switches some or all of the textual displays of the attributes for a single goal - - - e.g. saved 330, goal 331, end date 332, or monthly amount - - - to data editing displays 350. The user may use these data entry displays to quickly edit the values for a single goal stored in the allocation database 210.

An embodiment may also include a delete button 340 for each goal that allows the user to remove the information about the goal from the display 300. When a goal is removed from the display using this button, the user control and display interface 201 may cause the goal information to be permanently deleted from the allocation database 210 or simply marked as deleted in the database so it can be ignored as appropriate in any data processing actions by the user control and display interface 201, the allocation computation module 211, and the aggregation and analysis module 240. Removing a goal using this button may also initiate further data processing actions by those components of the system and method.

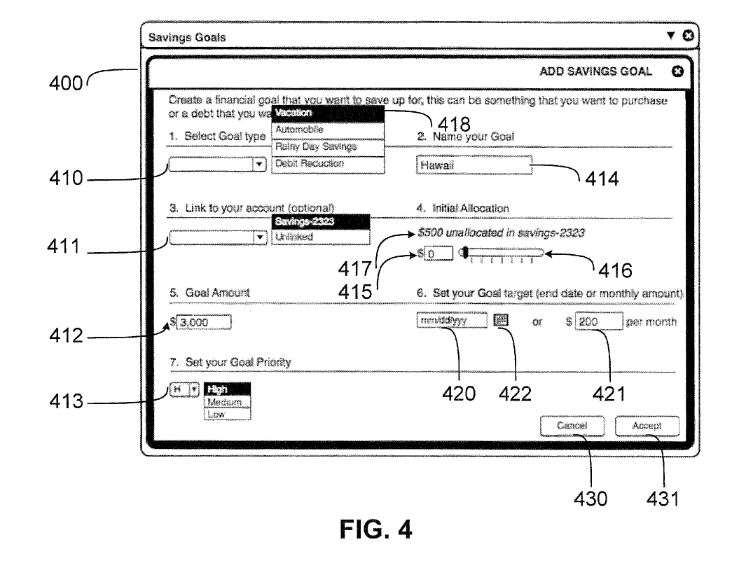

The display 300 in an embodiment may also include an “Add Savings Goal” button 360 that allows the user to interactively specify a new goal by entering information about the goal in the allocation database 210. In some embodiments, this button when activated may cause the user control and display module 200 to create a new goal on the display 300, in others it may cause presentation of another display 400 as shown in FIG. 4 for entering the required information about the goal as we further describe later.

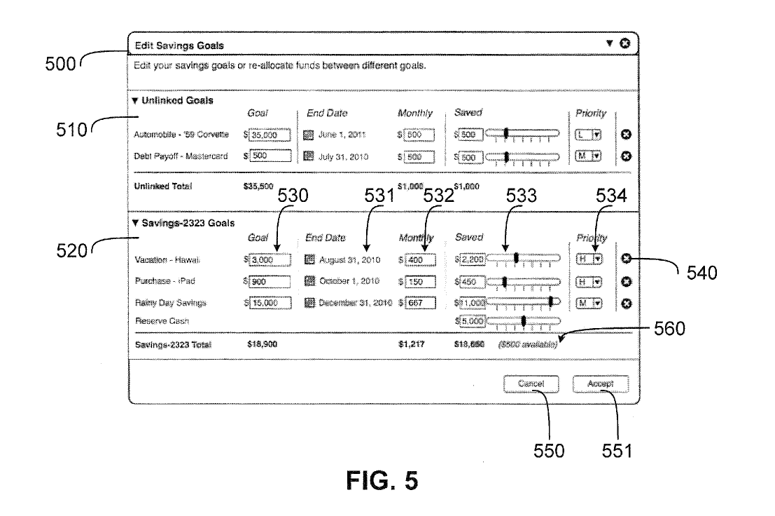

Some embodiments may also include an “Edit Savings Goal” button 361 that allows the user to conveniently and interactively edit information about all of the user's goals in the allocation database 210. When activated, this button may cause the user control and display module 200 to present another display 500 as shown in FIG. 5 for entering the required information about the goal as we further describe later.

The user controls and display module 200 of FIG. 1 that includes the displays 300, 400, and 500 of FIG. 3, FIG. 4, and FIG. 5, respectively, is the primary means by which the user interacts with those aspects of the system and method subject to the user's influence and control. This module receives input information from the user stored in the allocation database 210, and provides output information to the user retrieved from the database, via the user control and display interface 201.

The user control and display module 200 in a preferred embodiment of the system and method includes a means such as the display 400 in FIG. 4 for entering information about a new goal in the allocation database 210. The display includes selectors and data entry fields to allow the user to enter information about a new goal. These may include the category of the goal 410, the savings account from which automatic allocations of deposits will be made to the goal 411, the amount of the goal 412, a categorical priority for the user of the goal 413, a name for the goal 414, an initial allocation of funds to the goal 415, an end date by which the goal must be accomplished 420, or an amount to be allocated monthly to the goal 421.

In addition, the display includes a button 431 to allow the user to accept the goal and communicate the goal attributes to the allocation database 210 via the user controls and display interface 201. It also includes a button 430 to allow the user to exit the goal specification process without entering the goal in the database.

Several of the controls in the display 400 may be such that the allowable values for the goal attribute is selected from a limited number of options specified by the user control and display module 200. For instance, the goal type 410 may be specified as being in one of four categories: “Vacation,” “Automobile,” “Rainy Day Savings,” or “Debt Reduction.” The linked account 411 may be limited to the categories of “Savings” or “Unlinked.” The goal priority 413 may be specified as “High,” “Medium,” or “Low.” The linked account menu 411 may additionally allow the user to add a new linked account, rather than merely displaying previously linked accounts, to the system and method. In an embodiment, the linked account menu 411 may include an option “New Account” below “Savings” or “Unlinked” by, e.g., providing a separate screen or an expanded screen of the current display in which the user can enter data specific to the new account, e.g., account number, access code, account holder's name, account's nickname, and the like. The system and method have access to data from the linked accounts, e.g., account balances, but does not necessarily have access to the funds themselves. In another embodiment, the system and method may not only access data about the linked accounts but also be able to transfer funds from one account to another or from one account to an account it newly creates.

Other controls may be data entry fields for free-form numeric or text strings. This might include controls that permit the user to specify the goal amount 412, the user's name for the goal 414, the initial allocation to the goal 415, and the end date for the goal 420. These controls may include format validation to insure that the free-form numeric or text strings entered by the user represent the type of information required by the control. In addition, some may also include a companion alternative control that simplifies entry of the required information. For example, the initial allocation data entry field 415 may have a companion slider control 416. The end date data entry field 420 may have a companion data selector control 422 with an associated pop-up menu 418 that enumerates the possible selections.

For some of the user controls, the user controls and display module 200 may enforce extrinsic or intrinsic constraints on the information values entered by the user. For example, the initial allocation control 415 may limit the amount a user can allocate to the maximum amount not already allocated to other goals 417 linked to the same account as the goal 411. Similarly, if the user specifies an end date for the goal using the end date control 420, the module will supply a value for the monthly allocation 421 given the goal amount 412 and the initial allocation 415. If the user specifies a monthly allocation 421, the module supplies an end date 420.

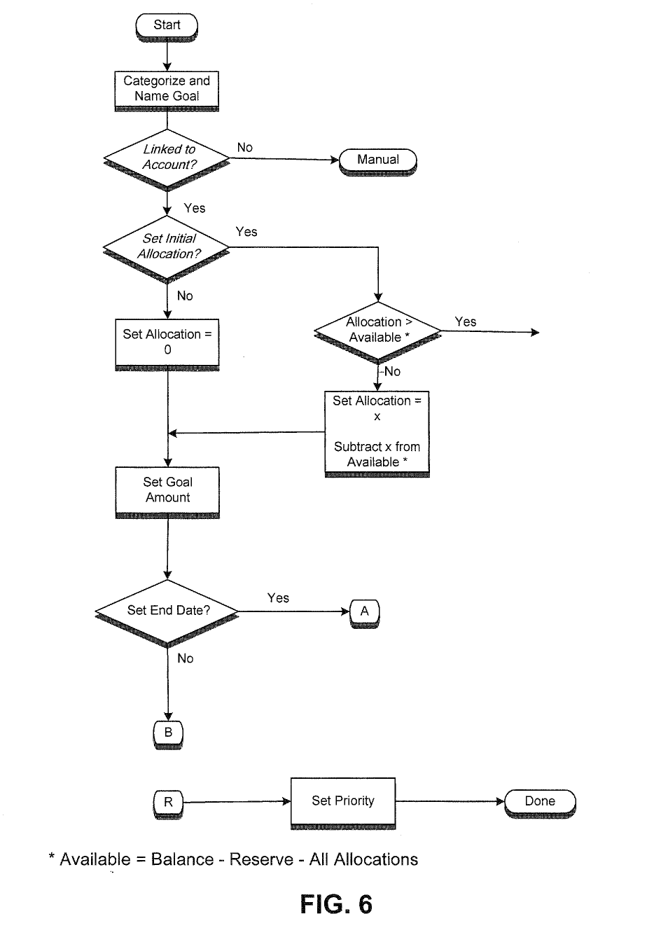

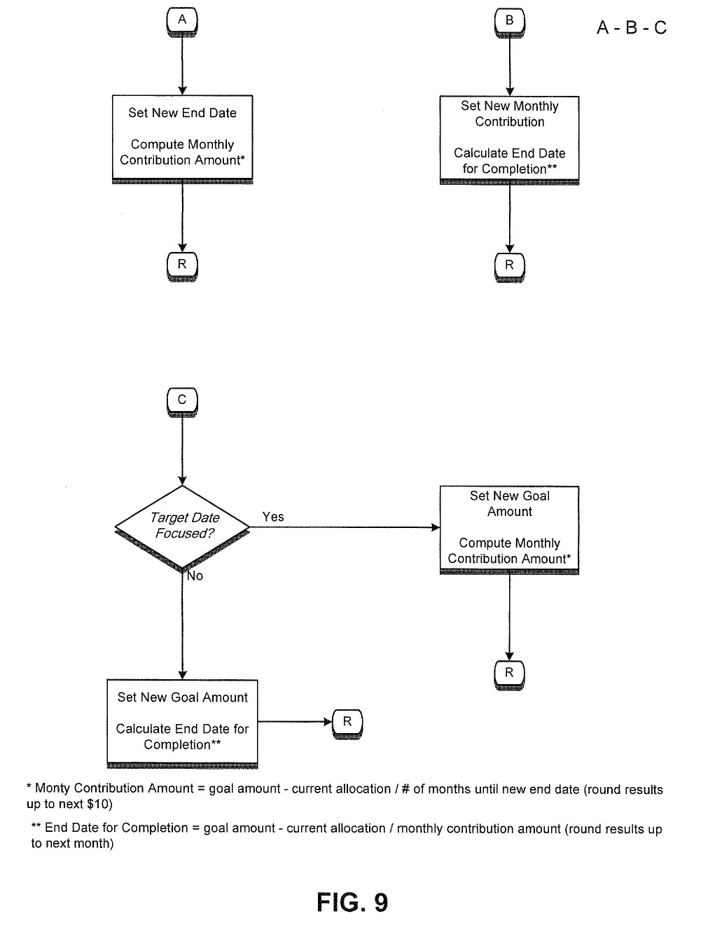

FIG. 6 and FIG. 9 together are flowcharts of an embodiment by which the user controls and display module 200 may interact with the user via the display 400 and the user control and display interface 101 to capture new goal information from the user and to derive the goal attributes described previously that are stored in the allocation database 210. By this process, the user may first use the goal type selector 410 and the goal name data entry field 414 to enter a category and name for the goal.

The user may then use the account selector 411 to specify whether the goal is linked to an account. In some embodiments, the display 400 may also include a data entry that allows the user to specify identifying information for an account. If the goal is linked to an account, the user may also use the initial allocation control 415 to specify an initial allocation to the account, limited to the maximum unallocated amount in the account 417.

Next the user may specify the amount of the goal using the goal amount data entry control 412. Having specified the goal amount, the user may then use the end date control 420 or the monthly allocation data entry field 421 to specify the corresponding information. The user controls and display module 200 may then supply the complementary value for the unspecified attribute of the goal. The user may then use the goal priority selector 413 to categorize the priority of the goal.

Finally the user may either use the accept button 431 to cause the goal information to be entered in the Allocation Data database 110, or to cause the user controls and display module 200 to terminate the process of adding a goal without entering any goal information in the allocation database 210.

The user control and display module 200 in a preferred embodiment of the system and method may also include a means such as the display 500 in FIG. 5 for editing the goal information in the allocation database 210 some or the entire user's goal. The display may include a section for the unlinked goals 510, and for each savings account 520 for the goals in that group. Each grouping of goals may include a display of additional information about the group including the total target amount, the total monthly amount being saved, and the total amount saved to date for all of the goals in the group.

For each goal, the display includes selectors and data entry fields that allow the user to edit some of the attributes of each goal in the allocation database 210. These may include the amount of the goal 530, the end date of the goal 531, the monthly allocation to the goal 532, the categorical priority for the user of the goal 534. In some embodiments, certain of the goal attributes originally specified by the user may not be modifiable. These may include the category and name of the goal or the savings account, if any, from which automatic allocations of deposits will be made to the goal.

The display 500 may also include a data entry field for the amount saved 533 that is initialized with the amount currently allocated to the goal at the time the display is activated by the user in response to the button 361 of the display 300 in FIG. 3. The user may adjust the amount that is currently allocated to the goal. Any adjustment is ultimately reflected in the goal amount for the goal in the allocation database 210 and the display of the amount available 560 in the savings account linked to that goal.

Finally, the display 500 may include a button 540 for each goal that allows the user to delete the goal. In some embodiments, this display may also include a control that allows the user to explicitly specify the goal has been completed and the funds for the goal have been withdrawn from the account.

In addition, the display includes a button 551 to allow the user to accept the changes made to all goals and communicate the edited goal attributes to the allocation database 210 via the User Controls and Display Interface 101. It also includes a button 550 to allow the user to exit the goal editing process without entering any modifications to the goal attributes in the database.

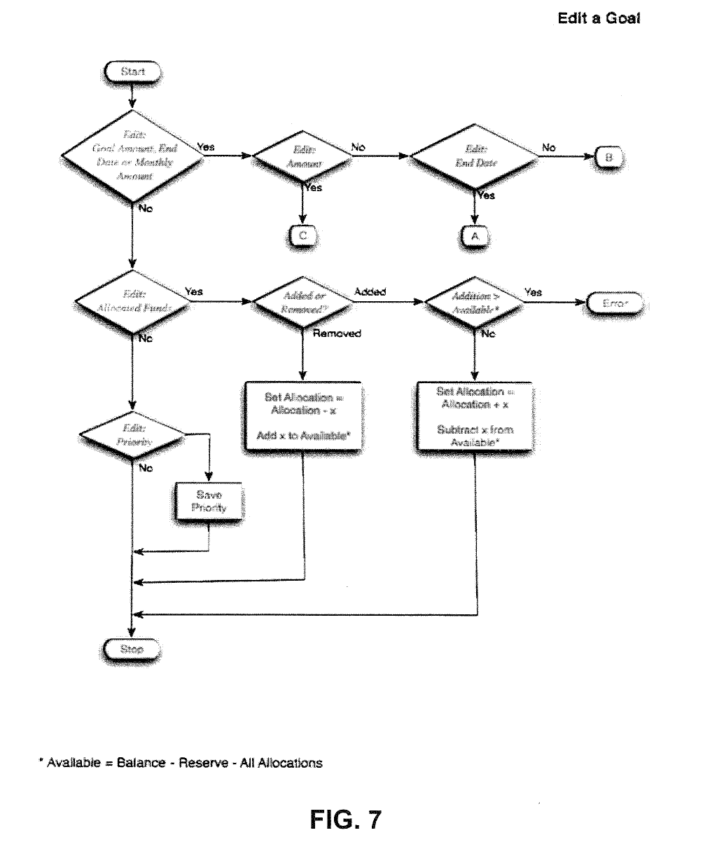

FIG. 7 and FIG. 9 together are flowcharts of one process by which the user controls and display module 200 may interact with the user via the display 500 and the user control and display interface 201 to edit the goal information stored in the allocation database 110. By this process, the user may then specify the end date or monthly contribution with the end date control 531 or the monthly allocation data entry field 532, respectively. The user controls and display module 200 may then supply the complementary value for the unspecified attribute of the goal.

Next the user may use the amount saved control 533 to adjust the amount allocated to the goal. Any adjustment is ultimately reflected in the goal amount for the goal in the allocation database 210 and the display of the amount still available 560 in the savings account linked to that goal.

Finally, the user may adjust the priority of the goal with the goal priority selector 534.

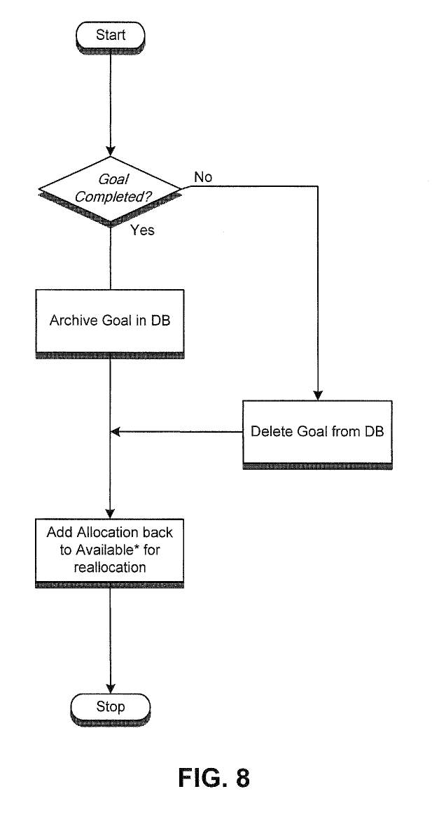

FIG. 8 is a flowchart of one process by which the user controls and display module 200 may interact with the user via the display 500 and the User Control and Display Interface 101 to delete the information for a goal stored in the allocation database 210. In response to user activation of the delete button 540 of display 500 in FIG. 5, in one embodiment a determination is made whether the goal is completed. A goal may be implicitly determined by this process to be completed if the amount saved as would be shown in the displays 330 and 533 equals the goal amount as would be shown in the displays 331 and 530, or in some embodiments the user may explicitly indicate that the goal has been completed.

If the goal is completed, the goal information in the allocation database 210 may supplemented to indicate this. The goal information with that indication may be retained in the database for subsequent retrieval and display to the user by the user controls and display module 200, or for further analysis by the aggregation and analysis module 240. The goal information for uncompleted goals may be deleted from the database.

Finally, any allocation to the goal as would be shown in displays 330 and 530 would be added back into the amount available 560 displayed for the account.

In some embodiments, the User Control and Display Module may include controls that allow the user to specify an alert indication should be activated when a one or more user-specifiable percentages of the goal has been reached. Once the goal reaches one of the specified percentage thresholds, an alert may be indicated for the goal 310 in the display 300. Some embodiments may also include means for providing external alerts to the user such as sending an email, or a post to the user's account on a social media platform.

In yet other embodiments, the user controls and display module 200 just described may be a component of another computer system which programmatically supplies and receives goal information from the user control and display interface 201.

Auto-Allocation of Deposits

Having just described the user displays and controls, we next describe a preferred embodiment of the system automatically allocating deposits to the goals.

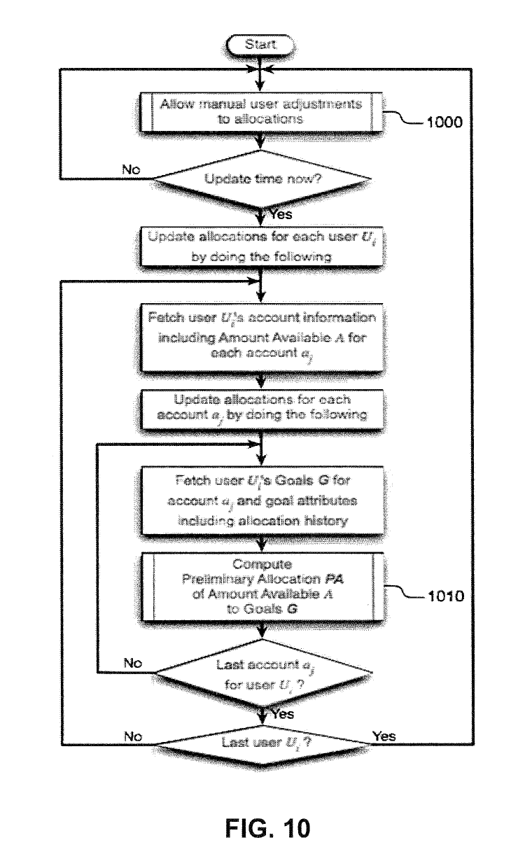

FIG. 10 is a top-level flowchart of the allocation process in embodiments of the system and method. As the flowchart depicts, some embodiments allocate “Available” funds in each account to the goals the user has linked to the account automatically on a regular basis (e.g., once every 24 hours) 1010. In between regular allocations, the system may allow the user to manually adjust the allocations 1000. Other embodiments may only do the automatic allocations 1010 on a regular basis and not permit manual user adjustments 1000 to those allocations. Yet other embodiments may only allow users to manually trigger automatic allocation and adjust the allocations subsequently 1000 but not do allocations on a regular basis 1010.

To determine the amount of “Available” funds in each account for allocation, an embodiment of the system and method may store the “Amount Saved” for each goal, the “Reserve Cash” for each account, and the “Current Balance” of the account. The amount “Available” then is the difference between the “Current Balance” and the total of the “Reserve Cash” and the “Amount Saved” for all goals linked to the account. The “Available” funds may be positive, indicating the account has a surplus of funds that must be allocated to the linked goals. It may also be negative, indicating the account has a deficit of funds must be de-allocated from the linked goals.

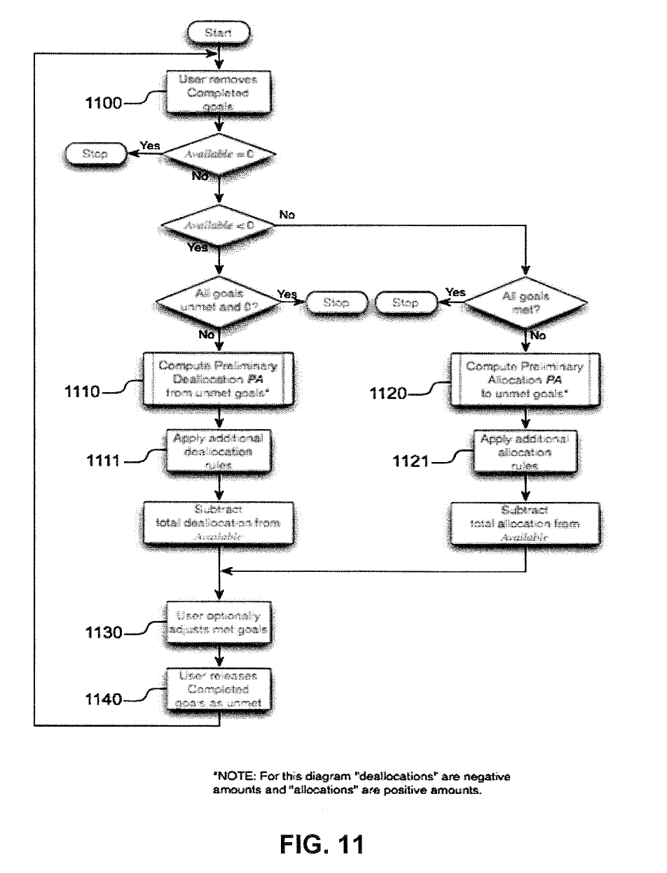

A flowchart for one example of the process 1000 in the flowchart FIG. 10 for automatically allocating available funds for one account to the goals the user has linked to that account is shown in FIG. 11. The process iterates until all “Available” funds in the account have been allocated to the goals linked to the account or all goals have been met. An iteration starts with the user optionally unlinking any completed goals from the account such as by activating the button 340 in the display screen 300 in FIG. 3, or by activating the button 540 from the display screen 500 in FIG. 5. The iteration ends at that point if there is no surplus of funds to allocate, and no deficit of funds to deallocate.

If there is a surplus of funds that must be allocated, but all goals are met, the iteration ends. If some goals are unmet, then a “Preliminary Allocation” PA of those funds 1120 to those unmet goals is computed based in part on the user's relative preferences for the goals linked to the account inferred from the user's interaction with the embodiment of the system and method. The preliminary allocation may then be automatically adjusted according to additional rules 1121. One such rule might be an absolute ad hoc limit on the amount that may be allocated to a single goal. The total amount of the adjusted allocation to all of the goals is then subtracted from the surplus of “Available” funds.

Conversely, if there is a deficit of funds that must be deallocated, but all of the goals are unmet and no funds have been allocated to any of the goals, the iteration ends. If some goals are unmet, then a “Preliminary (De-)Allocation” PA of those funds 1110 from those unmet goals is computed based in part on the user's relative preferences for the goals linked to the account inferred from the user's interaction with the embodiment of the system and method. The preliminary de-allocation may then be automatically adjusted according to additional rules 1111. One such rule might be an absolute ad hoc limit on the amount that may be de-allocated from a single goal. The total amount of the adjusted de-allocation from all of the goals is then subtracted from the surplus of “Available” funds. Here we indicate a de-allocation as a negative amount so that subtracting the de-allocation amounts to adding the total amount of the absolute value of the de-allocated funds back to the amount of “Available” funds.

After the surplus or deficit funds have been allocated or de-allocated, respectively, an embodiment of the system and method may provide the user with the means and opportunity to adjust the goals that have been met. These adjustments may include changing the “Goal Amount” 331 in the display 300 of FIG. 3, or the “End Date” 531 or “Monthly Contribution” 532 in the display 500 of FIG. 5. Making these adjustments may change the amount of surplus or deficit funds to be allocated or de-allocated in the next iteration of the process.

Next, an embodiment may provide the user with the means and opportunity to effectively release completed goals as unmet for purposes of the allocation process. In some points in the allocation process, such as when de-allocating a deficit of funds, completed goals may be treated differently from unmet goals or met goals. For instance, surplus funds may not be allocated to a completed goal or deficit funds may not be de-allocated from a completed goal. By releasing completed goals as unmet goals, the user may in effect allow the allocation process to allocate additional surplus funds to a completed goal or de-allocate deficit funds from a completed goal.

Finally, after all user adjustments have been made to the allocations determined, the process iterates starting with the user optionally unlinking any completed goals from the account such as by activating the button 340 in the display screen 300 in FIG. 3, or by activating the button 540 from the display screen 500 in FIG. 5.

Upon completion of the iterative allocation process some embodiments may also explicitly determine the user has met interim subgoals of a goal or completed a goal. If it is determined a subgoal has been met or a goal completed, the user may be offered incentives to induce the user to continue to attempt to achieve the goals the user has specified. Incentives may include, but are not limited to, visible indicators in the display 300 of FIG. 3, status indicators to other users the user has accomplished a goal, special offers for other financial products that may be offered by providers of those products, or coupons for products or services from businesses that have partnered with the savings account providers or the operator of the embodiment of the system and method.

Detailed Automatic Allocation Computation

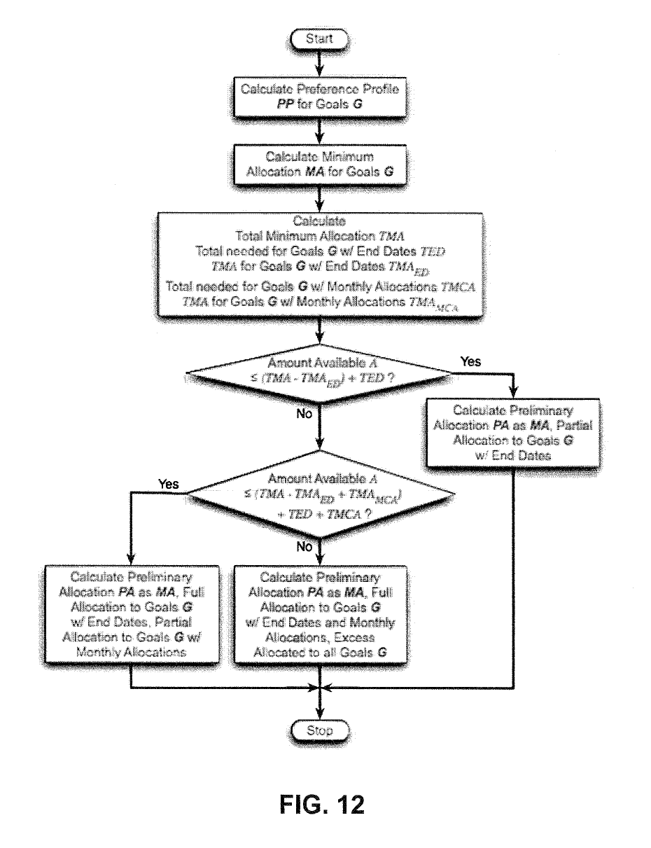

FIG. 12. is a flowchart for one example of the processes 1010, 1110, and 1120 in the flowcharts FIG. 10 and FIG. 11 for computing a Preliminary Allocation PA based in part on the user's relative preferences for the goals linked to the account inferred from the user's interaction with the embodiment of the system and method. The allocation computation is account focused and considers all of the goals for a specific account. To describe the computation we define the following parameters for goal i (with the associated goal attribute from the preceding discussion also indicated when it is relevant):

GoalAmountᵢ (GAᵢ): “Goal Amount”

GoalPriorityᵢ (GPᵢ): “Goal Priority”

StartDateᵢ (SDᵢ): Date savings toward goal starts

StartAmountᵢ (SAᵢ): Initial amount towards goal.

MonthlyContributionAmountᵢ (MCAᵢ): “Monthly Contribution Amount”

EndDateᵢ (EDᵢ): “End Date” This is the target date if the goal is date focused, it is an approximation based on the “Monthly Contribution Amount” if the goal is contribution focused.

AmountSavedᵢ (ASᵢ): Current total amount that has been allocated towards goal i.

ContributionDatesᵢ (CDᵢ), ContributionAmountsᵢ (CAᵢ), AllocationModeᵢ (MDᵢ): Time sequence of “Last Contribution Date” and “Last Contribution Amount” attribute values, and mode (batch/corrected/user) since saving towards goal started.

We also assume we have a set G={G₁, G₂, . . . , Gₙ} of active goals, with the parameters described for each goal Gᵢ and an available amount Available, or just A.

The computation results in a preliminary allocation PA={PA₁, PA₂, . . . , PAₙ} based on the allocation histories (CD₁, CA₁, MD₁=user), . . . , (CDₙ, CAₙ, MDₙ=user) such that

A=Σ_{i, G}_{_{iε}}_{G}PAᵢ

There are several problems to consider for allocating funds: The goals have different start dates and therefore we have varying amount of information from which we can infer preferences. In addition, some of the allocations in the history may have been made relative to goals that have been completed and therefore are no longer in G. Finally, one or more goals may be new and so we have no allocation history for them.

To help us sort out the preference inference problem, we first assume the goal priority attributes GPᵢ for the goals in G are authoritative. We then consider two possible options as the endpoints of a sequence of possibilities:

Minimum Inferences from Available History Data

For this approach, we have two additional exogenous parameters, a minimum allocation MA per goal and a total minimum allocation TMA for all goals.

First, we might simply compute a preference profile PP={PP₁, . . . , PPₙ} which only looks at goals for which the allocation history exists, over the time interval in which allocations have been made to all of those goals. Let the goals for which the allocation history exists be G_{>0}={Gⱼ|CAⱼ not nil}, let CD_{>0} be the earliest date such that an allocation has been made to every GⱼεG_{>0}, and let G^{c}_{>0}=G−G_{>0}. To get a ranking of these goals, we compute the fractions

pⱼ=(Σ_{k, CD}_{_{j,k}}_{>CD}_{_{>0}}CA_{j,k} such that MD_{j,k}=user)/(Σ_{l, G}_{_{lε}}_{G}_{_{>0}}Σ_{k, CD}_{_{l,k}}_{>CD}_{_{>0}}CA_{l,k} such that MD_{l,k}=user)

where the summation over the k index on the histories CDⱼ, CAⱼ, and MDⱼ should be understood to indicate these quantities are actually lists of values.

If we then let p=minⱼpⱼ, in one embodiment we can define a consistent preference profile as

$${PP}_{i} = \{ \begin{matrix}{p}_{i} / ( 1 + p \vert {G}_{> 0}^{c} \vert ) & if {G}_{i} ∈ {G}_{> 0} \\ p / ( 1 + p \vert {G}_{> 0}^{c} \vert ) & if {G}_{i} ∈ {G}_{> 0}^{c}\end{matrix}$$

This profile assigns a fraction of an allocation consistent with the p, for any goals which we have MDᵢ=user allocations and a minimum fraction of the allocation to any goals for which we have no information from the user to infer a preference.

Next, we establish a minimum allocation profile MA={MA₁, . . . , MAₙ}. Of course, we have to limit n·MA≦TMA≦A. In one embodiment, we might establish a minimum linear allocation profile as:

MAᵢ=MA+(i−1)[TMA−n·MA]/n

Other embodiments may use other minimum allocation profiles.

There is one detail we have to take care of in the minimum allocation profile. In some embodiments the computation may depend on a complete ordering of the goals and we may only have the categorization attributes GPᵢ and the preference profile PP just described. Using this information, the goals G may be ordered and the minimum allocation profile MA adjusted in three steps. First, partition the goals G into three subsets of goals G_{Low}, G_{Medium}, and G_{High} and order the goals in G_{Low} before the goals in G_{Medium}, and the goals in G_{Medium} before the goals in G_{High}. Using the preference profile PP, we can order the goals in each of these subsets.

First the goals are ordered according to the three subsets defined by the goal priority attributes GPᵢ.

Next, in each subset the goals GᵢεG^{c}_{>0} are ordered before the goals GᵢεG_{>0}.

Finally, using G_{High} as an example, the goals GᵢεG_{>0} ∩G_{High} are partitioned into subsets G_{High,l}, . . . , G_{High,k} of goals that have the same value of PPᵢ and ordered according to those subsets. For those subsets G_{High,k} that include more than one goal Gᵢ, the minimum allocation profile can be adjusted so that each goal within G_{High,k} has the same minimum allocation

MAᵢ′=Σ_{i, G}_{_{iε}}_{G}_{_{High,k}}MAⱼ/|G_{High,k}|

Some embodiments may also consider the MonthlyContributionAmountᵢ (MCAᵢ) the user has specified or derive a minimum monthly contribution amount from a user-specified EndDateᵢ (EDᵢ). Let G_{MCA} and G_{ED} be the goals for which the user has specified a monthly contribution amount MCAᵢ or an end date EDᵢ, respectively, and for which the monthly contribution has not yet been made for that month and perhaps previous months. In some embodiments, the preliminary allocation may be distributed across the specified monthly contributions for all of the goals in G_{MCA}∪G_{ED}. These funds might be re-distributed by the user and those redistributions would subsequently show up in the preference profile PP. In those embodiments if the monthly contribution for previous months has not been for one goal, then in effect no goals are up-to-date and there is no need to distinguish between goals that are months behind and those that aren't in this step of the preliminary allocation.

Let ASTᵢ (AmountSavedTargetᵢ) be the amount that should be saved by the end of the current month to meet the user's goals and let the total monthly contribution “in arrears” for the goals in G_{MCA} and G_{ED}, respectively, be

TMCA=Σ_{i, G}_{_{iε}}_{G}_{_{MCA}}(ASTᵢ−ASᵢ) TED=Σ_{i, G}_{_{iε}}_{G}_{_{ED}}(ASTᵢ−ASᵢ)

TMA_{MCA}=Σ_{i, G}_{_{iεG}}_{_{MCA}}MAᵢ TMA_{ED}=Σi, G_{_{iε}}_{G}_{_{ED}}MAᵢ

We also let the preference masses in each of the different groups of goals be:

PP_{MCA}=Σ_{i, G}_{_{ε}}_{G}_{_{MCA}}PPᵢ PP_{ED}=Σ_{i, G}_{_{iε}}_{G}_{_{ED}}PPᵢ PP_{>0}=Σ_{i, G}_{_{i εG}}_{_{>0}}PPᵢ

The preliminary allocation PA={PA₁, PA₂, . . . PAₙ} of the AmountAvailable A must be derived in three possible cases:

Case 1: A≦(TMA−TMA_{ED})+TED

In this case, the available funds A are sufficient to meet the minimum monthly allocation MA, but are not sufficient to meet the required monthly allocations for goals G_{ED} with specified end dates EDᵢ. Any excess funds above the minimum allocation MA are distributed to the required monthly allocations for goals Gᵢ with specified end dates G_{ED} as

$${PA}_{i} = \{ \begin{matrix}{MA}_{i} & if {G}_{i} ∉ {G}_{ED} \\ {MA}_{i} + ( A - TMA ) \cdot {PP}_{i} / {PP}_{ED} & if {G}_{i} ∈ {G}_{ED}\end{matrix}$$

Case 2: (TMA−TMA_{ED})+TED<A≦(TMA−TMA_{ED}−TMA_{MCA})+TED+TMCA

In this case, the available funds A are sufficient to meet the minimum monthly allocation MA and the required monthly allocations for goals G_{ED} with specified end dates EDᵢ, but are not sufficient to meet those goals G_{MCA} with specified monthly contributions MCAᵢ. Any excess funds above the minimum allocation MA and the required monthly allocations for goals Gᵢ with specified end dates G_{ED} are distributed to the required monthly allocations for goals Gᵢ with specified monthly allocations G_{MCA} as

$$\{ \begin{matrix}{MA}_{i} & \begin{matrix}if {G}_{i}^{∉} ∉ {G}_{ED} and \\ {G}_{i}^{∉} ∉ {G}_{MCA}\end{matrix} \\ {AST}_{i} - {AS}_{i} & if {G}_{i} ∈ {G}_{ED} \\ {MA}_{i} + [ A - ( TMA - {TMA}_{ED} ) - TED ] \cdot {PP}_{i} / {PP}_{MCA} & if {G}_{i} ∈ {G}_{MCA}\end{matrix}$$

Case 3: (TMA−TMA_{ED}−TMA_{MCA})+TED+TMCA<A

In this case, the available funds A are sufficient to meet the minimum monthly allocation MA and the required monthly allocations both for goals G_{ED} with specified end dates EDᵢ and goals G_{MCA} with specified monthly contributions MCAᵢ. Let TA=A−(TMA−TMA_{ED}−TMA_{MCA})+TED+TMCA. Any excess funds above these three categories of allocations are distributed to all goals as

$${PA}_{i} = \{ \begin{matrix}{MA}_{i} + {PP}_{i} \cdot TA & if {G}_{i}^{∉} ∉ {G}_{ED} and {G}_{i}^{∉} ∉ {G}_{MCA} \\ ( {AST}_{i} - {AS}_{i} ) + {PP}_{i} \cdot TA & if {G}_{i} ∈ {G}_{ED} or {G}_{i} ∈ {G}_{MCA}\end{matrix}$$

This preliminary allocation does not allocate more than A, but it must be massaged according to rules dealing with how close a goal is to being accomplished, missed monthly goals, over-allocations, etc. Note also this algorithm would work for de-allocation, although all of the quantities must be interpreted appropriately.

Minimum Inferences from Available History Data

In the previous embodiments, a preliminary allocation PA is derived across the goals in G with minimum inferences on the available history data. In particular, the preference profile PP is derived by only looking at the period in time in which the user had explicitly ranked the goals in G_{>0} by making allocations to them.

Other embodiments may use the available history data CDᵢ, CAᵢ, MDᵢ=user differently to make a preliminary allocation PA. Let CDS denote a date sometime before the current date that defines the start of a time window and let CD_{j,>0}≧CDS represent the earliest date in the window which the user started make a contributions to goal Gⱼ. If the user started to contribute to goal Gⱼ before CDS, then CD_{j,>0}=CDS. G_{>0} is now understood to represent the goals for which the user has made any contribution. The probabilities forming the basis for the preference profile then computed as

pⱼ=(Σ_{k, CD}_{_{j,k}}_{>CD}_{_{j,>0}}CA_{j,k} such that MD_{j,k}=user)/(Σ_{l, G}_{_{lε}}_{G}_{_{>0}}Σ_{k, CD}_{_{l,k}}_{>CD}_{_{l,>0}}CA_{l,k} such that MD_{l,k}=user)

The preliminary allocation PA is then made as before. When the preference profile is built in this way, it in effect incorporates an additional inference about the user's relative preferences for the goals based on how long the user has been saving for each goal.

Yet other embodiments may incorporate a different set of inferences about a user's preferences by normalizing the contributions a user has made to each goal relative to the time they have been saving for each goal. Let TD represent today's date and, as a notational convenience, let ∥TD−CDS∥ denote the length of the window in days and ∥TD−CD_{j,>0}∥ denote the length of time the user has been saving for goal Gj. In these embodiments the probabilities forming the basis for the preference profile then computed as

pⱼ=[(∥TD−CDS∥/∥TD−CD_{j,>0}∥)·Σ_{k, CD}_{_{j,k}}_{>CD}_{_{j,>0}}CA_{j,k} where MD_{j,k}=user]/[Σ_{l, G}_{_{lε}}_{G}_{_{>0}}(∥TD−CDS∥/∥TD−CD_{l,>0}∥)·Σ_{k, CD}_{_{l,k}}_{>CD}_{_{l,>0}}CA_{l,k} where MD_{l,k}=user]

When the preference profile is built in this way, it de-emphasizes the effect of how long the user has been saving for a goal. It still attempts, however, to give influence to the total amount a user has actually contributed to each goal by assuming the user would have contributed the same amount in the past to more recent goals as they actually contributed to those goals.

The preceding description discloses the preferred embodiments of the inventive system and method. Without further elaboration, it is believed that one skilled in the art can use the preceding description to utilize the system and method to its fullest extent. Therefore the examples and embodiments disclosed herein are to be construed as merely illustrative and not a limitation of the scope of the system and method in any way.

It will be obvious to those having skill in the art that many changes may be made to the details of the above-described embodiments without departing from the underlying principles of the system and method. Therefore, it is to be understood that the system or method should not be limited to the specific embodiments disclosed and that modifications and other embodiments are intended to be included within the scope of the appended claims.

The scope of the present system and method, therefore, should be determined only by the following claims.

1. An apparatus, comprising:
a memory device configured to:
store information identifying at least one user account; and
store user preferences corresponding to at least one savings goal;
a processing device configured to:
detect a deposit of funds into the at least one user account;
automatically allocate the deposit in response to the user preferences; and
cause a display of progress towards meeting the at least one savings goal in response to automatically allocating the deposit.

2. The apparatus of claim 1, wherein the information identifying the at least one user account includes institution name, account number, account name, account nickname, account password, or account type.

3. The apparatus of claim 1, wherein the user preferences includes goal category, goal name, goal amount, end date, contribution amount, or goal priority.

4. The apparatus of claim 1, wherein the display of progress includes a graphical or textual display of amount saved towards the at least one savings goal, amount remaining to meet the at least one savings goal, status of the at least one savings goal, or contributions or allocations towards the at least one savings goal.

5. The apparatus of claim 1, wherein the display of progress includes a target marker, bar graph, or textual summary of progress towards meeting the at least one savings goal.

6. The apparatus of claim 1, wherein the processing device is further configured to compile statistics associated with the at least one savings goal.

7. The apparatus of claim 6, wherein the processing device is further configured to mine data stored in the memory device for patterns associated with the at least one savings goal.

8. A method, comprising:
identifying at least one user account;
identifying at least one savings goal;
detecting a deposit of funds into the at least one user account;
automatically allocating the deposit in response to the at least one savings goal; and
displaying progress towards meeting the at least one savings goal in response to automatically allocating the deposit.

9. The method of claim 8, wherein identifying the at least one user account includes identifying at least one of institution name, account number, account name, account nickname, account password, or account type.

10. The method of claim 8, wherein identifying at least one savings goal includes identifying at least one of goal category, goal name, goal amount, end date, contribution amount, or goal priority.

11. The method of claim 8, wherein displaying the progress includes graphically or textually displaying an amount saved towards the at least one savings goal, an amount remaining to meet the at least one savings goal, a status of the at least one savings goal, contributions made towards the at least one savings goal, or allocations made towards the at least one savings goal.

12. The method of claim 8, wherein displaying the progress includes displaying a target marker, a bar graph, or a textual summary of progress towards meeting the at least one savings goal.

13. The method of claim 8, further comprising:
compiling statistics associated with the at least one savings goal; and
displaying the statistics.

14. A memory device having instructions stored thereon that, in response to execution by a processing device, cause the processing device to perform operations comprising:
identifying at least one user account;
identifying at least one savings goal;
detecting a deposit of funds into the at least one user account;
automatically allocating the deposit in response to the at least one savings goal; and
displaying progress towards meeting the at least one savings goal in response to automatically allocating the deposit.

15. The memory device of claim 14, wherein the operations further comprise identifying at least one of institution name, account number, account name, account nickname, account password, or account type.

16. The memory device of claim 14, wherein the operations further comprise identifying at least one of goal category, goal name, goal amount, end date, contribution amount, or goal priority.

17. The memory device of claim 14, wherein the operations further comprise graphically or textually displaying an amount saved towards the at least one savings goal, an amount remaining to meet the at least one savings goal, a status of the at least one savings goal, contributions made towards the at least one savings goal, or allocations made towards the at least one savings goal.

18. The memory device of claim 14, wherein the operations further comprise displaying a target marker, a bar graph, or a textual summary of progress towards meeting the at least one savings goal.

19. The memory device of claim 14, wherein the operations further comprise:
compiling statistics associated with the at least one savings goal; and
displaying the statistics.
